(19) United States
(12) Patent Application Publication
(10) Pub. No.: US 2009/0066459 A1
(43) Pub. Date: Mar. 12, 2009

(54) Transformer Structure

(75) Inventor: Lee Huang Chih, Hua-Tan Hsiang (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: DELTA ELECTRONICS, INC., Taoyuan Hsien (TW)

(21) Appl. No.: 12/029,003

(22) Filed: Feb. 11, 2008

(30) Foreign Application Priority Data
Sep. 8, 2007 (CN) 200720177106.4

(51) Int. Cl. H01F 27/30

(52) U.S. Cl. 336/198

(57) ABSTRACT

A transformer structure is provided. The transformer structure comprises at least one first winding frame, at least one second winding frame, a plurality of primary coil assemblies which are wound around the at least one first winding frame, a plurality of secondary coil assemblies which are wound around the at least one secondary winding frame, and an iron core assembly which is placed in the jacks of the at least one first winding frame and the at least one second winding frame. The at least one first winding frame has a plurality of primary coil areas, around which the primary coil assemblies are wound. The at least one second winding frame has a plurality of secondary coil areas, around which the secondary coil assemblies are wound.

This application claims the benefit of priority based on China Patent Application No. 200720177106.4, filed on Sep. 8, 2007, the contents of which are incorporated herein by reference in their entirety.

### CROSS-REFERENCES TO RELATED APPLICATIONS

Not applicable.

### BACKGROUND OF THE INVENTION

1. Field of the Invention

The present invention relates to a transformer structure, more particularly, relates to a transformer structure that can increase the leakage inductance of a transformer.

2. Descriptions of the Related Art

As shown in FIG. 1, a conventional transformer comprises a first winding frame 10, a second winding frame 11, and an iron core 12. The first winding frame 10 has a first primary coil portion 100 and at least two first secondary coil portions 101. The second winding frame 11 is assembled with the first winding frame 10, and has a second primary coil portion 110 and at least two second secondary winding portions 111. The two primary coils are wound on the first primary coil portion 100 and the second primary coil portion 110 respectively, and are electrically connected to each other. A plurality of secondary coils are wound around each of the first secondary coil portions 101 and each of the second secondary coil portions 111. The first winding frame 10 and the second winding frame 11 have a jack 102 and a jack 112 respectively. The iron core 12 is inserted into the jacks 102, 112. Also as shown in FIG. 1, the primary coils and the secondary coils of such a transformer structure share a common magnetic circuit which may decrease the leakage inductance.

However, for high-voltage transformers, a high leakage inductance is typically needed to meet the resonance frequency requirements. Thus, increasing the leakage inductance of an integral transformer is a key factor in designing high-voltage transformers.

In view of this, it is important to provide a new transformer structure that may increase the leakage inductance of an integral transformer.

### SUMMARY OF THE INVENTION

The primary objective of this invention is to provide a transformer structure, which comprises multiple magnetic circuits, so that the the overall leakage inductance is increased. In addition, independent magnetic circuits for the primary coils and the secondary coils can also be provided.

A transformer structure is disclosed in this invention. The transformer structure comprises at least one first winding frame, at least one second winding frame, a binding site, a plurality of primary coil assemblies, a plurality of secondary coil assemblies, and an iron core assembly. The at least one first winding frame has a jack and a plurality of primary coil portions, while the at least one second winding frame has a jack and a plurality of secondary coil portions. The at least one first winding frame and the at least one second winding frame are coupled through the binding site to form a transformer base. The primary coil assemblies and the secondary coil assemblies are wound on the transformer base. More specifically, the primary coil assemblies are wound around the primary coil portions, while the secondary coil assemblies are wound around the secondary coil portions. The iron core assembly is placed in the jacks of the at least one first winding frame and the at least one second winding frame. A partition with a jack is formed between two adjacent primary coil portions. Similarly, another partition with a jack is formed between two adjacent secondary coil portions. The jacks of both the first winding frame and the partition of the primary coil portions are adapted to communicate with each other. Similarly, both the jacks of the second winding frame and the partition of the secondary coil portions are adapted to communicate with each other. The jack of the at least one first winding frame is formed integrally with the at least one first winding frame, or is formed in the first winding frame using a cutting process subsequent to the formation of the first winding frame. Similarly, the jack of the at least one second winding frame is formed integrally with the at least one second winding frame, or is formed in the second winding frame using a cutting process subsequent to the formation of the second winding frame. The iron core assembly further comprises a plurality of first iron cores and a second iron core. Each of the first iron cores has an extension accommodating the jacks of the at least one first winding frame and the at least one second winding frame. The second iron core is an I-type iron core, which is inserted into the jacks of the partitions of the at least one first and at least one second winding frame, and abuts against the extensions of the first iron cores.

This invention may form multiple single magnetic circuits via the base and the iron core assembly, and the coupling between the individual magnetic circuits may further increase the overall leakage inductance of the transformer, thereby to satisfy the requirement of the high-voltage transformer. Moreover, the primary and the secondary coils of the transformer have respective independent magnetic lines of force, so that only after the magnetic lines of force is generated in the primary coils can an electromotive force be generated passively in the secondary coils.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram illustrating the exploded view of a conventional transformer structure;

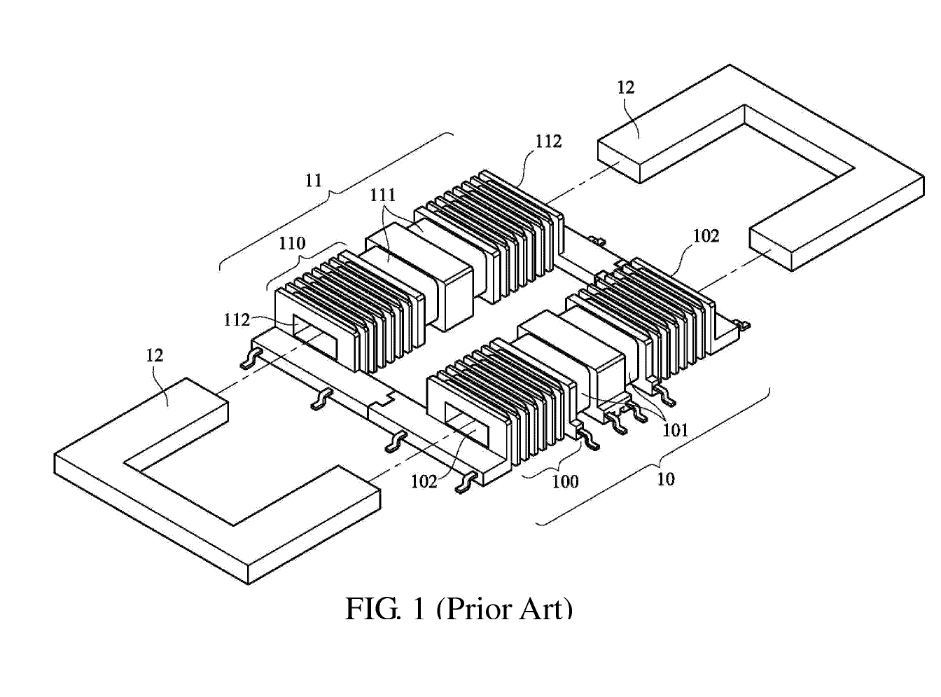

FIG. 2 is a schematic diagram illustrating the preferred embodiment of this invention; and

FIG. 3 is a schematic diagram illustrating the exploded view of the preferred embodiment of this invention.

### DESCRIPTION OF THE PREFERRED EMBODIMENT

A detailed description of a transformer structure of this invention will be made hereinafter with reference to the attached drawings and specific embodiments thereof.

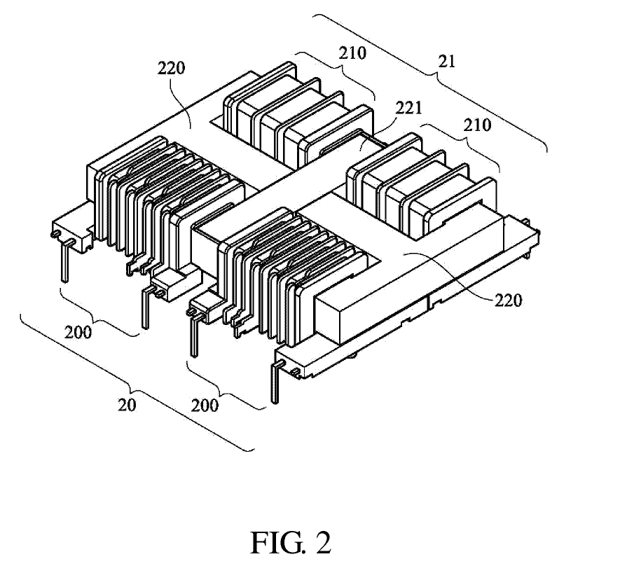

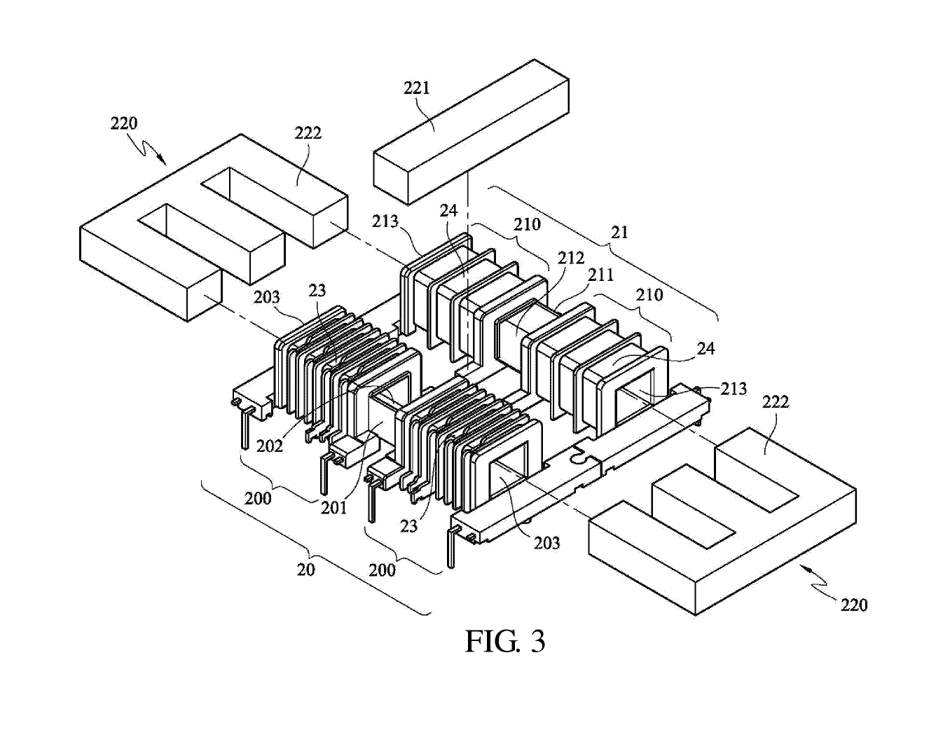

As shown in FIGS. 2 and 3, a preferred embodiment of this invention is a transformer structure, which comprises a first winding frame 20 and a second winding frame 21. The first winding frame 20 and the second winding frame 21 are coupled to each other via a binding site to form a transformer base. The first winding frame 20 has a jack 203, and the second winding frame 21 has a jack 213. Two primary coil assemblies 23 are wound around the first winding frame 20, and two secondary coil assemblies 24 are wound around the second winding frame 21. The iron core assembly comprises two first iron cores 220 and a second iron core 221. The first iron cores 220 are inserted into the jack 203 of the first winding frame 20 and the jack 213 of the second winding frame 21. The first winding frame 20 has two more primary coil portions 200, while the two primary coil assemblies 23 are wound around the primary coil portions 200 respectively. A partition 201 with a jack 202 is formed between the two primary coil portions 200. The jack 203 of the first winding frame 20 and the jack 202 of the partition 201 between the primary coil portions 200 communicate with each other.

The second winding frame 21 has two secondary coil portions 210 corresponding to the first winding frame 20, while the two secondary coil assemblies 24 are wound around the secondary coil portions 210 respectively. A partition 211 with a jack 212 is formed between the two secondary coil portions 210. The jack 213 of the second winding frame 21 and the jack 212 of the partition 211 between the secondary coil portions 210 communicate with each other.

The jack 203 is integrally formed with the first winding frame 20, or is formed in the first winding frame 20 by a cutting process subsequent to the formation of the first winding frame 20. Similarly, the jack 213 is integrally formed with the second winding frame 21, or is formed in the second winding frame 21 using a cutting process subsequent to the formation of the second winding frame 21.

Each of the first iron cores 220 of the iron core assembly has an extension 222 for fitting with the jacks of the first winding frame 20 and the second winding frame 21. The second iron core 221 is an I-type iron core, which is inserted into the jack 202 of the partition 201 of the first winding frame 20 and the jack 212 of the partition 221 of the second winding frame 21, and abuts against the extensions 222 of the first iron cores 220.

With the transformer base and the iron core assembly described above, a plurality of single magnetic circuits may be formed. The coupling between these individual magnetic circuits may further increase the overall leakage inductance of the transformer to satisfy the operating requirements of the high-voltage transformer. Moreover, the primary coils and the secondary coils of the transformer have respective independent magnetic lines of force, which is adapted to meet the resonance frequency requirements of the high-voltage transformer.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A transformer structure, comprising:
at least one first winding frame having a jack;
at least one second winding frame having a jack;
a binding site for coupling the at least one first winding frame and the at least one second winding frame to form a transformer base;
a plurality of primary coil assemblies and a plurality of secondary coil assemblies both adapted to be wounded around the transformer base; and
an iron core assembly placed in the jacks of the at least one first winding frame and the at least one second winding frame;
wherein the at least one first winding frame has a plurality of primary coil portions in which the primary coil assemblies are wound, and the adjacent two of the primary coil portions have a partition which is provided with a jack;
wherein the at least one second winding frame has a plurality of secondary coil portions, the secondary coil assemblies are wound around the secondary coil portions, adjacent secondary coil portions have a partition with a jack.

2. The transformer structure as claimed in claim 1, wherein the jack of the at least one first winding frame and the at least one first winding frame are formed integrally.

3. The transformer structure as claimed in claim 1, wherein the jack of the at least one first winding frame is formed in the at least one first winding frame by a cutting process.

4. The transformer structure as claimed in claim 1, wherein the jack of the at least one second winding frame and the at least one second winding frame are formed integrally.

5. The transformer structure as claimed in claim 1, wherein the jack of the at least one second winding frame is formed in the at least one second winding frame by a cutting process.

6. The transformer structure as claimed in claim 1, wherein the jack of the at least one first winding frame and the jack of the partition of the primary coil portions are adapted to communicate with each other.

7. The transformer structure as claimed in claim 6, wherein the jack of the at least one first winding frame and the at least one first winding frame are formed integrally.

8. The transformer structure as claimed in claim 6, wherein the jack of the at least one first winding frame is formed in the at least one first winding frame by a cutting process.

9. The transformer structure as claimed in claim 1, wherein the jack of the at least one second winding frame and the jack of the partition of the secondary coil portions are adapted to communicate with each other.

10. The transformer structure as claimed in claim 9, wherein the jack of the at least one second winding frame and the at least one second winding frame are formed integrally.

11. The transformer structure as claimed in claim 9, wherein the jack of the at least one second winding frame is formed in the at least one second winding frame by a cutting process.

12. The transformer structure as claimed in claim 1, wherein the iron core assembly comprises:
a plurality of first iron cores, each having an extension accommodating the jacks of the at least one first winding frame and the at least one second winding frame; and
a second iron core, being an I-type iron core, is inserted into the jacks of the partitions of the at least one first winding frame and the at least one second winding frame, and abuts against the extension portions of the first iron cores.
